(19) United States
(12) Patent Application Publication
(10) Pub. No.: US 2025/0101731 A1
(43) Pub. Date: Mar. 27, 2025

(54) A CONNECTING STRUCTURE FOR MECHANICALLY CONNECTING STEEL PIPE PROFILES TO EACH OTHER TO FORM A TRUSS STRUCTURE AND A TRUSS STRUCTURE

(71) Applicant: Hämeen ammattikorkeakoulu Oy, HÄMEENLINNA (FI)

(72) Inventor: Jarmo Havula, HÄMEENLINNA (FI)

(73) Assignee: Hämeen ammattikorkeakoulu Oy, HAMEENLINNA (FI)

(21) Appl. No.: 18/728,301

(22) PCT Filed: Dec. 21, 2022
(86) PCT No.: PCT/FI2022/050864

§ 371 Date: Jul. 11, 2024

(30) Foreign Application Priority Data
Jan. 11, 2022 (FI) 20225016

(51) Int. Cl. E04B 1/24; E04C 3/04

(52) U.S. Cl. CPC E04B 1/2403; E04B 2001/2418; E04C 2003/0486

(57) ABSTRACT

The object of the invention is a connecting structure for mechanically connecting steel pipe profiles (1, 2, 3) to each other to form a truss structure, comprising at least one elongated frame beam (1) with a rectangular cross-section, to which several cross struts (2, 3) with a rectangular cross-section forming a truss structure and extending diagonally and/or perpendicularly with respect to the frame beam are connected. According to the invention, receiving openings (4, 5) are formed on one side (6) of the frame beam (1) for receiving one end (2a, 3a) of each cross strut (2, 3) into the frame beam. Fastening holes (12) and/or outlines thereof are formed in the region of the end (2a, 3a) of the cross strut (2, 3) extending into the frame beam (1), and corresponding fastening holes (12′) and/or outlines thereof are formed on the sides (7, 8) of the frame beam (1) perpendicular to the side (6) having the receiving openings (4, 5). Guide holes (9, 9′) are formed on the sides (7, 8) of the frame beam perpendicular to the side (6) having the receiving openings (4, 5) and equipped with at least one guide pin (10, 10′) extending in the transverse direction of the frame beam. A guide groove (11, 11′) extending in the longitudinal direction of the cross strut (2, 3) is formed at the end (2a, 3a) of the cross strut, which, in cooperation with said at least one guide pin (10, 10′), positions the fastening holes (12) of the cross strut (2, 3) and the corresponding fastening holes (12′) of the frame beam (1) in exact alignment, enabling fastening means (13) to be inserted precisely through the fastening holes (12, 12′), thereby rigidly connecting the pipe profiles (1, 2, 3) to each other. A further object of the invention is a truss structure (16) utilizing the connecting structure.

The object of the invention is a connecting structure and a truss structure utilizing such a connecting structure. The connecting structure is a connecting structure for mechanically connecting steel pipe profiles to each other to form a truss structure, comprising at least one elongated frame beam with a rectangular cross-section, to which a plurality of cross struts with a rectangular cross-section forming a truss structure and extending diagonally and/or perpendicularly to the frame beam are connected.

There are various uses for truss structures made of pipe profiles, such as in roof trusses, footbridges, masts, escalators, etc. Joints between the pipe profiles are often made by welding, but mechanical joints, such as those implemented with hard metal screws, are also used. These joints are as such functional with typical structural steels, but with high-strength structural steels having a yield strength of preferably approximately 700 MPa or more, the problem in welded joints is a decrease in strength in the heat-affected zone, and on the other hand, in mechanical joints, hard metal screws do not sufficiently penetrate high-strength steel. The invention may already prove useful with steels having a yield strength of approximately 500 MPa or more and a hardness in the order of 160 to 215 HV or more.

Previously known solutions have been presented in publications U.S. Pat. No. 3,826,057A and JP2009197437A, for example. In these solutions, pipe profiles are mechanically connected to each other to form a truss structure.

The aim of the present invention is to provide a connecting structure in which pipe profiles can be mechanically connected to each other to form a truss structure also when using high strength structural steel.

To achieve this aim, the connecting structure of the invention is characterized in that receiving openings are formed on one side of the frame beam for receiving one end of each cross strut into the frame beam;
that fastening holes and/or outlines thereof are formed in the region of the end of the cross strut extending into the frame beam, and corresponding fastening holes and/or outlines thereof are formed on the sides of the frame beam perpendicular to the side containing the receiving openings;
that guide holes are formed on the sides of the frame beam perpendicular to the side containing the receiving openings, said guide holes being equipped with at least one guide pin extending in the transverse direction of the frame beam; and
that a guide groove is formed at the end of the cross strut, preferably a guide groove extending in the longitudinal direction of the cross strut, wherein said guide groove, in cooperation with said at least one guide pin, positions the fastening holes of the cross strut and the corresponding fastening holes of the frame beam in exact alignment, enabling fastening means to be inserted precisely through the fastening holes, thereby connecting the pipe profiles rigidly to each other.

Preferably, said guide groove formed at the end of the cross strut is a guide groove extending in the longitudinal direction of the cross strut. Alternatively, said guide groove formed at the end of the cross strut extends at an acute angle with respect to the longitudinal direction of the cross strut, wherein the angle is essentially less than 90 degrees, preferably at most 45 degrees.

The material of the pipe profiles is preferably high-strength structural steel with a yield strength of approximately 700 MPa or more, and a hardness typically in the order of 230 to 300 HV or more, wherein the fastening holes and/or guide holes are made smaller than the diameter of the fastening means/guide pins used by means of laser machining, and the edges of the holes have been softened by means of laser machining or heat treatment so as to allow the fastening means/guide pins to penetrate through the undersized holes. Preferably, the edges of the holes are softened such that the hardness of the edge is approximately ⅓ to ½ of the hardness of the fastening means/guide pins. The fastening means are preferably hard metal screws penetrating the pipe profile when driven in. The surface hardness of hard metal screws is usually approximately 450 HV or more. The surface hardness of self-tapping screws is at least 450 HV 0.3 according to SFS-EN ISO 2702:2011, and the surface hardness of self-drilling screws is at least 530 HV 0.3 according to SFS-EN ISO 10666:2000. Thus, the edges of the holes are softened to a value of approximately 225 HV or less. The target value can be considered to be 0.38 of the value of the surface hardness of the screw. Sufficient softening is confirmed with the help of tests depending on the type of fastening means (e.g. the thread size and the hardness profile beyond the surface) and the material thickness of the high-strength structural steel plate in relation to the diameter of the fastening means. With a thicker plate, the probability of the thread breaking increases, hence in a thicker plate, the edge of the hole should be relatively softer. The fastening means may also be, for example, slightly conical fastening pins inserted into the fastening holes by shooting or pressing.

Next, the invention is described with reference to the accompanying drawings, in which:

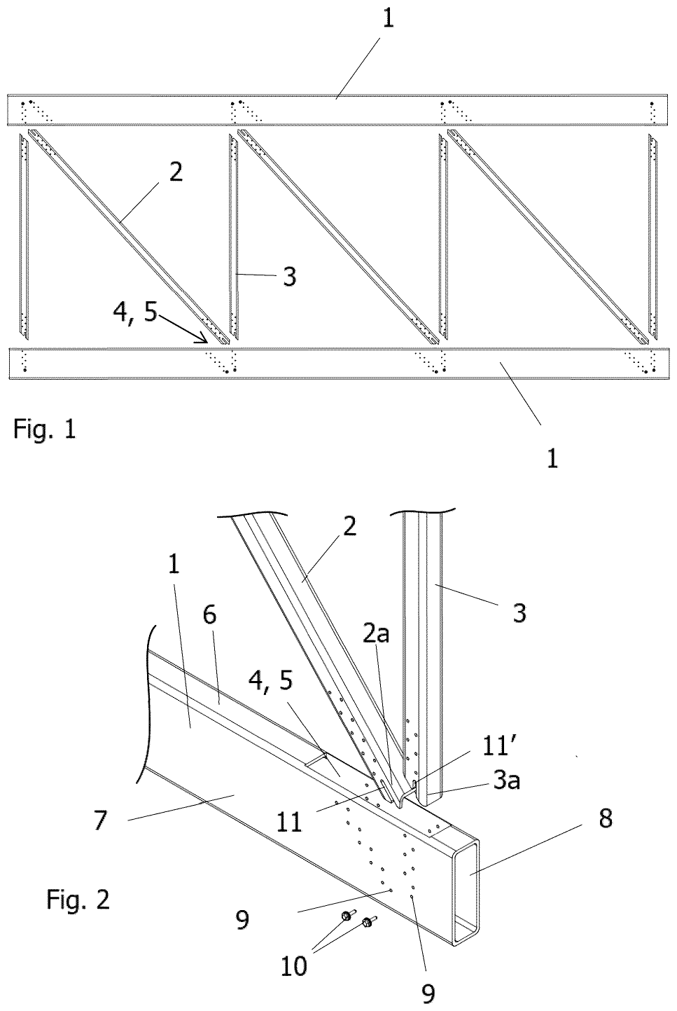

FIG. 1 is a schematic side view of a truss structure using the connecting structure according to the invention before assembly,

FIG. 2 is a schematic perspective view of a part of the truss structure of FIG. 1,

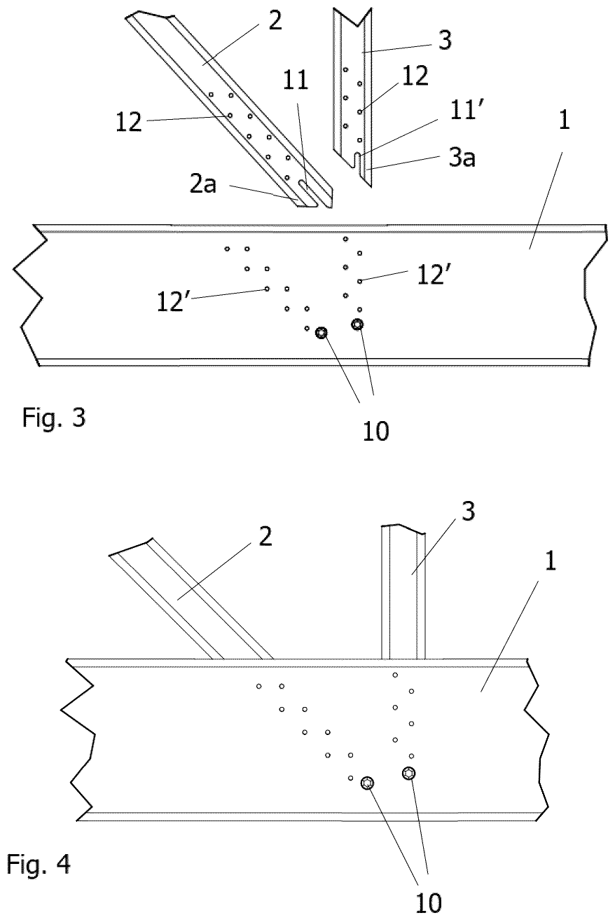

FIG. 3 is a schematic side view of a part of the truss structure of FIG. 1,

FIG. 4 is a schematic side view of a part of the truss structure of FIG. 1 with the cross struts installed in place,

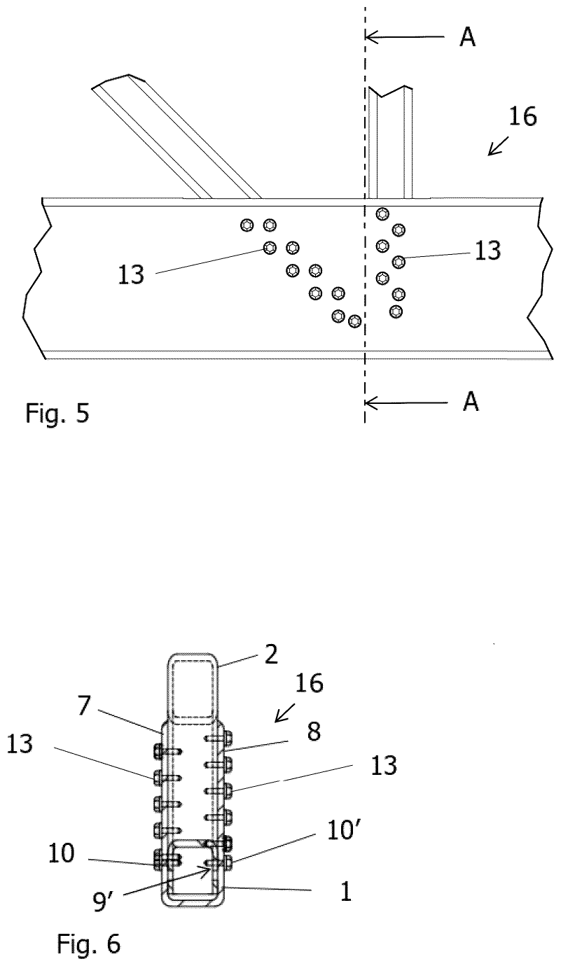

FIG. 5 is a schematic side view of the situation in FIG. 4 with the cross struts installed in place,

FIG. 6 is a cross-section of FIG. 5 in the direction of the arrows A-A,

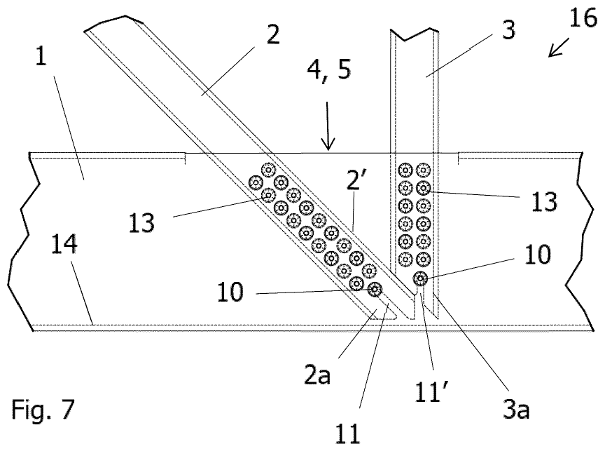

FIG. 7 is a side view of a connecting structure in which several fastening screws have been used, wherein the parts of the cross struts located inside the frame beam are shown with dashed lines to illustrate the position of the cross struts in an assembled situation, and

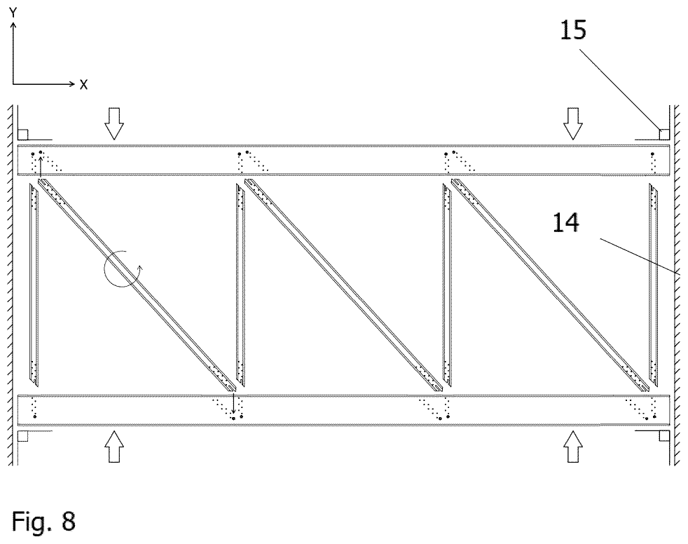

FIG. 8 is a schematic principle view of the use of an installation jig for assembling the truss structure.

FIG. 1 shows a truss structure utilizing the connecting structure according to the invention before assembly. The truss structure consists of frame beams 1 having cross struts 2, 3 connected therebetween. The frame beams 1, as well as the cross struts 2, 3, have a rectangular cross-section. Receiving openings 4, 5 are formed on one side 6 of the frame beam 1 for inserting one end 2a, 3a of each cross strut 2, 3 into the corresponding frame beam 1 to form a connecting structure. The receiving openings 4, 5 may be formed as a continuous opening for receiving the ends of the adjacent diagonal 2 and perpendicular 3 cross struts through the same opening, as in the example shown in the figures. Guide holes 9, 9′ equipped with guide pins 10, 10′ extending in the transverse direction of the frame beam are formed on the sides 7, 8 of the frame beam perpendicular to the side 6 containing the receiving openings. The guide holes 9, 9′ are preferably undersized and their edges are softened such that a self-tapping screw constituting the guide pin 10, 10′ can be driven into place. The part of the guide pin 10, 10′ extending into the frame beam is preferably smooth. The guide pin can also be formed so as to be continuous across the entire interior of the frame beam. A guide groove 11, 11′ extending in the longitudinal direction of the cross strut is formed at the end of the cross strut 2, 3 and arranged to cooperate with corresponding guide pins 10, 10′. Several, preferably undersized fastening holes 12 are formed in the region of the end 2a, 3a of the cross strut 2, 3 extending into the frame beam, and corresponding, preferably undersized fastening holes 12′ are formed on the sides 7, 8 of the frame beam perpendicular to the side 6 containing the receiving openings. The fastening holes 12, 12′ and the guide holes 9, 9′ are preferably formed by means of laser machining, which provides precise positioning of the holes. Laser machining can also be used to heat-treat the edges of the holes to allow the fastening means to penetrate through the undersized holes for fastening the parts to each other rigidly. Heat treatment can be performed when the fastening holes are made, or afterwards. In the case of screw fasteners 13, heat treatment of the edges of the holes is preferably extended so as to cover the thickness of the thread. The fastening holes 12, 12′ of the cross struts 2,3 and the frame beam 1 can be guided into alignment with the help of the guide groove 11, 11′ of the cross strut and the guide pins 10, 10′ of the frame beam. It is also possible to just form outlines for the fastening holes by marking the positions of the fastening holes and softening the cross strut and/or the frame beam at the fastening hole positions so that the fastening means, such as self-drilling hard metal screws, can be inserted through the steel at the outlined position without a pilot hole. The end 2a of the cross strut 2 inserted diagonally to the frame beam is preferably shaped so that it is positioned at a short distance from the inner bottom 14 of the frame beam. The end 3a of the cross strut 3 perpendicular to the frame beam is, on the other hand, preferably shaped so that it is positioned at a short distance from the top surface 2′ of the diagonal cross strut 2.

Assembling the truss structure preferably takes place on a horizontal surface by placing the end 2a, 3a of each cross strut 2, 3 inside the frame beam 1 through the corresponding receiving opening 4, 5. FIG. 2 shows the parts of the connecting structure before the assembly phase in more detail as a perspective view. FIG. 3 shows the parts of the connecting structure before the assembly phase as a side view. In FIG. 3, the guide pins 10 on the front side 7 are positioned in the guide holes 9, and the guide pins 10′ on the back side 8 respectively in the corresponding guide holes 9′. In FIG. 4, the cross struts 2, 3 have been installed in place as guided by the guide grooves 11, 11′ and the guide pins 10, 10′, after which the fastening screws 13 are inserted through the undersized fastening holes 12, 12′, thereby firmly attaching the cross struts and the frame beam to each other. FIG. 5 shows the connecting structure in the assembled state as a side view. FIG. 6 shows the cross-section of the connecting structure as seen in the direction of the arrows A-A. FIG. 7 shows the connecting structure as a side view, wherein the parts inside the frame beam are shown with dashed lines to illustrate the position of the cross struts in the assembled state. The lower end of the diagonal cross strut 2 is preferably spaced at a short distance from the inner bottom 14 of the frame beam. The lower end of the perpendicular cross strut 3 is preferably spaced from the top surface 2′ of the diagonal cross strut by a small gap. In the embodiment of FIG. 7, more fastening screws 13 are used than in the embodiments of FIG. 1-6.

FIG. 8 shows the connection of steel pipe profiles 1-3 into a truss structure in an installation jig using the connecting structure according to the invention as a schematic principle view. The installation jig shown as an example includes lateral supports 14 placed on a horizontal installation surface and extending in the longitudinal direction (y-direction) of the installation surface, wherein frame beams 1 extending in the transverse direction (x-direction) are placed at a longitudinal distance from one another between said lateral supports. Cross struts 2, 3 are placed between the frame beams and arranged at the receiving openings 4, 5 of the frame beam. The frame beams 1 are then moved evenly in the y-direction towards the cross struts 2, 3 and each other using displacement means 15 while keeping the longitudinal axes of the frame beams in alignment with the x-direction. The lateral supports 14 prevent the frame beams 1 from moving in the x-direction. When the ends of the cross struts 2, 3 move through the openings 4, 5 and the guide grooves 11, 11′ therein meet the guide pins 10, 10′, the cross struts 2 start to twist slightly, and in their final position, reach an angle in which the fastening holes 12, 12′ are aligned. The connecting structure can also be put together without an installation jig by inserting the end 2a, 3a of the cross strut 2, 3 through the receiving opening 4, 5 so that the guide groove 11, 11′ meets the guide pins 10, 10′. When the guide pins are positioned against the bottom of the guide groove, the fastening holes can be aligned manually and the fastening means 13 inserted into the fastening holes 12, 12′. When the first fastening means is installed in place, the rest of the fastening holes remain aligned without further adjustment.

Structurally, the guide groove 11, 11′ is preferably such that it extends through the opposite sides of the cross strut 2, 3. The guide groove 11,11′ has an open end in the longitudinal direction of the cross strut 2, 3. The guide groove 11, 11′is dimensioned such that said at least one guide pin 10, 10′ fits to move into the guide groove 11, 11′ via the open end of the guide groove 11, 11′ in the longitudinal direction of the cross strut 2, 3, particularly when moving the cross strut 2, 3 in its longitudinal direction or at least essentially in its longitudinal direction towards said at least one guide pin 10,10′.

In the embodiments presented, a plurality of fastening holes 12 and/or outlines thereof are formed on each opposite side of the respective cross strut 2, 3 in the region of the end 2a, 3a of the cross strut 2, 3 extending into the frame beam 1 for improving the rigidity of the connection between the cross struts 2, 3 and the frame beam 1. Corresponding fastening holes 12′ and/or outlines thereof are formed on the sides 7, 8 of the frame beam 1 perpendicular to the side 6 containing the receiving openings 4, 5. In the embodiment presented, said plurality of fastening holes 12 and/or outlines thereof comprises at least two, preferably more than two fastening holes 12 and/or outlines thereof, the number being nine in the case of the diagonal beam 2 and six in the case of the perpendicular beam 3 in the preferred solution presented. When there are several fastening holes 12 and/or outlines thereof, their positions may be distributed evenly, and they may be dimensioned to be relatively small so that they fit well in the beams to be connected without issues with space. Fastening through several fastening holes contributes to the rigidity of the joint and can be implemented without excessively weakening the structure. Therefore, it is generally preferable that said plurality of fastening holes 12 and/or outlines thereof comprises at least six fastening holes 12 and/or outlines thereof.

In the embodiments presented, said plurality of fastening holes 12 and/or outlines thereof comprises two adjacent lines extending in the longitudinal direction of the cross strut 2, 3, wherein each line comprises two or more fastening holes 12 and/or outlines thereof in succession in the longitudinal direction of the cross strut 2, 3. With the holes being relatively small in size and large in number, the line formation allows a large number to be positioned in a small area.

As stated above, to increase the rigidity of the joint, it is preferred that a plurality of fastening holes 12 and/or outlines thereof are formed on each opposite side of the respective cross strut 2, 3 in the region of the end 2a, 3a of the cross strut 2, 3 extending into the frame beam 1. This is advantageous, but not compulsory. In some cases, it may be possible to achieve sufficient rigidity with only one fastening hole 12 and/or outline thereof formed on each opposite side of the respective cross strut 2, 3 in the region of the end 2a, 3a of the cross strut 2, 3 extending into the frame beam 1. Even one fastening hole 12 on each side, together with the guide holes 9, 9′ and the fastening means 13 and respective guide pins 10, 10′ installed thereto, may be enough to form a rigid joint that cannot twist.

FIG. 5-7 show details of the assembled truss structure 16. As shown in the figures, the truss structure 16 comprises an elongated frame beam 1 with a rectangular cross-section and cross struts 2, 3 with a rectangular cross-section (of which two are shown) connected to the frame beam 1 with any previously described connecting structure such that the cross strut 2 extends diagonally with respect to the frame beam 1 and the cross strut 3 extends perpendicularly with respect to the frame beam 1. One end 2a, 3a of each cross strut 2, 3 extends into the frame beam 1 through a receiving opening 4, 5 formed on one side 6 of the frame beam 1. The truss structure 16 comprises fastening means 13 extending through the fastening holes 12 of the cross struts 2, 3 and the fastening holes 12′ of the frame beam 1. The truss structure 16 further comprises guide pins 10, 10′ extending through the guide holes 9, 9′ into the guide grooves 11, 11′.

Generally, each said frame beam 1 and cross strut 2, 3 is preferably an elongated beam with a rectangular cross-section, which is a steel pipe profile.

It is obvious to a person skilled in the art that the idea and operating principle of the invention may be implemented in various ways. The invention and its implementation are therefore not limited to the examples described hereinbefore but may vary within the scope of the claims.

1. A connecting structure for mechanically connecting steel pipe profiles to each other to form a truss structure, comprising at least one elongated frame beam with a rectangular cross-section, to which one or more cross struts with a rectangular cross-section and extending diagonally and/or perpendicularly to the frame beam, are arranged to be connected, wherein receiving openings are formed on one side of the frame beam for receiving one end of each cross strut into the frame beam; characterized in that fastening holes and/or outlines thereof are formed in the region of the end of the cross strut extending into the frame beam, and corresponding fastening holes and/or outlines thereof are formed on the sides of the frame beam perpendicular to the side containing the receiving openings; and that guide holes are formed on the sides of the frame beam perpendicular to the side containing the receiving openings, said guide holes being equipped with at least one guide pin extending in the transverse direction of the frame beam; and that a guide groove is formed at the end of the cross strut, which, in cooperation with said at least one guide pin, is arranged to position the fastening holes of the cross strut and the corresponding fastening holes of the frame beam in exact alignment, enabling a fastener to be inserted precisely through the fastening holes, thereby rigidly connecting the pipe profiles to each other.

2. The connecting structure according to claim 1, characterized in that the guide groove is a guide groove extending in the longitudinal direction of the cross strut, or a guide groove extending at an acute angle with respect to the longitudinal direction of the cross strut, wherein said angle is preferably at most 45 degrees.

3. The connecting structure according to claim 1, characterized in that a separate guide pin is arranged in each guide hole.

4. The connecting structure according to claim 1, characterized in that a continuous guide pin is arranged between the opposite said guide holes.

5. The connecting structure according to claim 1, characterized in that the fastening holes are made smaller than the diameter of the fastener used and/or the guide holes are made smaller than the guide pins used.

6. The connecting structure according to claim 1, characterized in that the material of the pipe profiles is high strong structural steel with a yield strength of 700 MPa or more, wherein the fastening holes and/or guide holes are made, preferably by means of laser machining, smaller than the diameter of the fastening means and/or guide pins used, and that the edges of the holes have been made softer than the hardness of the fastening means and/or the guide pins used by means of laser machining or heat treatment, allowing the fastening means and/or the guide pins to penetrate through the undersized holes.

7. The connecting structure according to claim 1, characterized in that the fastener comprises are screws.

8. The connecting structure according to claim 1, characterized in that the fastener comprises conical fastening pins, particularly for insertion by shooting or pressing into the fastening holes.

9. The connecting structure according to claim 1, characterized in that the material of the pipe profiles is high-strength structural steel with a yield strength of 700 MPa or more, wherein the outlines of the fastening holes are formed by softening the position of the fastening holes by means of laser machining to enable the fastening means to be inserted through the steel without a pilot hole.

10. The connecting structure according to claim 1, characterized in that the edges of the fastening holes or outlines thereof in the structural steel are softened such that their hardness is ⅓ to ½ of the hardness of the fastening means used, preferably 0.38× the hardness of the fastener.

11. The connecting structure according to claim 1, characterized in that one or more fastening holes and/or outlines thereof are formed on each opposite side in the region of the end of the cross strut extending into the frame beam, and corresponding fastening holes and/or outlines thereof are formed on the sides of the frame beam perpendicular to the side containing the receiving openings.

12. The connecting structure according to claim 1, characterized in that a plurality of fastening holes and/or outlines thereof are formed on each opposite side in the region of the end of the cross strut extending into the frame beam, and corresponding fastening holes and/or outlines thereof are formed on the sides of the frame beam perpendicular to the side containing the receiving openings, wherein said plurality of fastening holes and/or outlines thereof comprises at least two, preferably more than two, preferably at least five fastening holes and/or outlines thereof.

13. The connecting structure according to claim 12, characterized in that each said plurality of fastening holes and/or outlines thereof comprises one or more lines of fastening holes and/or outlines thereof extending in the longitudinal direction of the cross strut, preferably two adjacent lines extending in the longitudinal direction of the cross strut, wherein each line comprises two or more fastening holes and/or outlines thereof in succession in the longitudinal direction of the cross strut.

14. The connecting structure according to claim 1, characterized in that the guide groove has an open end in the longitudinal direction of the cross strut.

15. The connecting structure according to claim 14, characterized in that the guide groove is dimensioned such that said at least one guide pin fits to move into the guide groove via said open end in the longitudinal direction of cross strut, particularly when moving the cross strut at least essentially in its longitudinal direction towards said at least one guide pin.

16. The connecting structure according to claim 1, characterized in that it comprises one or more cross struts, wherein each said cross strut is an elongated beam with a rectangular cross-section.

17. A truss structure comprising at least one elongated frame beam with a rectangular cross-section and cross struts with a rectangular cross-section connected to the frame beam with a connecting structure according to claim 1 such that the cross struts extend diagonally and/or perpendicularly with respect to the frame beam.

18. The truss structure according to claim 17, characterized in that it comprises a fastener extending through the fastening holes of the cross struts and the fastening holes of the frame beam.

19. The truss structure according to claim 17, characterized in that it comprises guide pins extending through the guide holes into the guide grooves.

20. The truss structure according to claim 17, characterized in that one end of each cross strut extends into the frame beam through a receiving opening formed on one side of the frame beam.

21. The connecting structure or truss structure according to claim 17, characterized in that each said cross strut is an elongated beam with a rectangular cross-section.
